(19) United States
(12) Patent Application Publication
(10) Pub. No.: US 2010/0129087 A1
(43) Pub. Date: May 27, 2010

(54) METHOD AND SYSTEM FOR PROVIDING BROADCASTING SERVICE IN VISIBLE LIGHT COMMUNICATION APPARATUS

(75) Inventors: Do-Young Kim, Yongin-si (KR); Dae-Seok Kim, Seoul (KR); Eun-Tan Won, Seoul (KR); Tae-Han Bae, Seongnam-si (KR); Chi-Hong Cho, Suwon-si (KR); Jae-Seung Son, Suwon-si (KR)

Correspondence Address: THE FARRELL LAW FIRM, LLP, 290 Broadhollow Road, Suite 210E, Melville, NY, 11747, US

(73) Assignee: Samsung Electronics Co., Ltd.

(21) Appl. No.: 12/626,115

(22) Filed: Nov. 25, 2009

(30) Foreign Application Priority Data
Nov. 26, 2008 (KR) 10-2008-0118299

(51) Int. Cl. H04B 10/04

(52) U.S. Cl. 398/182

(57) ABSTRACT

A method and system for providing a broadcast service in a visible light communication system are provided. When a visible light communication terminal receives broadcast mode announcement information from a communication control apparatus, a broadcast mode is set, and uplink data transmission is prohibited during the broadcast mode.

### PRIORITY

This application claims priority to an application entitled “Method and System for Providing Broadcasting Service in Visible Light Communication System” filed in the Korean Industrial Property Office on Nov. 26, 2008 and assigned Serial No. 10-2008-0118299, the contents of which are incorporated herein by reference.

### BACKGROUND OF THE INVENTION

1. Field of the Invention

The present invention relates generally to a visible light communication method and apparatus, and more particularly to a method system and system for broadcasting data in a visible light communication service using a time division scheme.

2. Description of the Related Art

In recent years, as LEDs (Light Emitting Diodes) have improved in luminous efficiency and have decreased in price, LEDs have become increasingly popular in special lighting markets for portable devices, displays, automobiles, traffic lights, advertising billboards, etc., as well as in the normal lighting markets for fluorescent lamps, incandescent lights, etc. Research into wireless visible light communication using visible light LEDs has recently been conducted in many enterprises and research institutes. This research is a result of interest in wireless optical technologies complementary to Radio Frequency (RF) technologies has been increasing due to an exhaustion of RF frequencies, possible interference between several wireless communication technologies, increased requirements for communication security, and an advent of ubiquitous ultra-high-speed communication environments using 4^{th} Generation (4G) wireless technology.

Visible light communication, which is information delivery using visible lights, advantageously provides secure communication, uses a broadband, and can be freely used without any regulation. Further the places where visible light reaches or the direction in which visible light travels can be seen by the naked eye, and thus the reception range of information transmitted by visible light communication can be accurately discovered. Visible light communication can provide reliable security, and can be driven with low power consumption. Therefore, visible light communication may be applied in hospitals and airplanes, where RF usage is restricted, and may provide additional information services via an electric bulletin board. Hereinafter, such visible light communication will be discussed with reference to the accompanying drawings.

FIG. 1 illustrates a structure of a conventional Visible Light Communication (VLC) system. The typical VLC system includes a light source 10 consisting of an LED or a LD (Laser Diode), which serves as lighting equipment and simultaneously performs data transmission/reception using visible light, and a visible light communication terminal 20 having a visible light transceiver module, which performs data transmission/reception with the light source. The visible light communication terminal 20 may include a mobile terminal, such as a cellular phone or Portable Digital Assistant (PDA), and a fixed terminal in the form of a desktop terminal. Additionally, visible light communication may be more effectively used in combination with wired/wireless communication systems using other communication mediums.

When using a wide space to provide a visible light communication service, multiple light sources 10 may be installed into a corresponding space, depending on the coverage of each light source 10. As illustrated in FIG. 2, for example, there may be multiple light sources 10 on the ceiling of one room. Also, in consideration of the coverage area over which one light source 10 can provide an optical communication service, a plurality of light sources 10 may be positioned in the form of a lattice at a predetermined distance from each other.

When multiple light sources 10 are installed at a predetermined distance from each other, as illustrated in FIG. 2, coverage areas of the respective light sources 10 may substantially overlap with each other, coverage areas of the respective light sources 10 may directly border each other, or there may be areas of non-coverage between coverage areas of the respective light sources 10. The case where coverage areas of the respective light sources 10 border each other is merely an ideal scenario, and thus does not commonly exist. In general, coverage areas of multiple light sources overlap with each other, or there are non-coverage areas between coverage areas of multiple light sources.

When multiple light sources, the coverage areas of which overlap with each other, provide different types of services, the services cannot be properly provided in overlapping areas because there are collisions between data transmitted through the different types of services. In particular, if one light source provides a broadcasting service, and a visible light communication terminal, which exists in the coverage area of another light source providing a one-to-one communication service, transmits data in uplink, then there may be interference between the uplink of the visible light communication terminal and the downlink used for the broadcasting service. When there is interference between the uplink and the downlink, the broadcasting service may not be properly provided.

### SUMMARY OF THE INVENTION

Accordingly, the present invention has been made to solve at least the above-mentioned problems occurring in the prior art, and an aspect of the present invention provides a method and apparatus for properly providing a broadcasting service in a visible light communication system.

Also, an aspect of the present invention is to provide a broadcasting service method and apparatus, which can prevent interference due to uplink data transmission of a visible light communication terminal when a broadcasting service is provided in a visible light communication system.

In accordance with an aspect of the present invention, there is provided a method for providing a visible light communication terminal with a visible light communication service in a time division visible light communication system that provides the service in various transmission schemes, the method including receiving transmission mode announcement information corresponding to one of the various transmission schemes from a communication control apparatus providing the visible light communication service; checking the transmission mode announcement information, and storing a result of the checking in the visible light communication terminal; and when the result of the checking shows that a broadcast mode is set, preventing uplink data transmission from the visible light communication terminal.

In accordance with another aspect of the present invention, there is provided a visible light communication terminal that is provided with a broadcast service in a time division visible light communication system that provides the broadcast service, a multicast service, and a unicast service, the visible light communication terminal. The terminal includes a light emitting device; a light receiving device; and a controller for outputting a user notification indicating a broadcast mode when the light receiving device receives broadcast mode announcement information from a communication control apparatus providing a visible light communication service, and prohibiting uplink data transmission during the broadcast mode.

### BRIEF DESCRIPTION OF THE DRAWINGS

The above and other aspects, features and advantages of the present invention will be more apparent from the following detailed description taken in conjunction with the accompanying drawings, in which:

FIG. 1 is a view illustrating a structure of a conventional visible light communication system;

FIG. 2 is a view illustrating multiple light sources provided in one location;

FIG. 3 is a view illustrating a structure of a visible light communication system in accordance with an embodiment of the present invention;

FIG. 4 is a block diagram illustrating a structure of a communication control apparatus in accordance with an embodiment of the present invention;

FIG. 5 is a block diagram illustrating a structure of a visible communication terminal in accordance with an embodiment of the present invention;

FIG. 6 is a flowchart illustrating an operation procedure of a visible light communication terminal in accordance with an embodiment of the present invention;

FIG. 7 is a view illustrating a transmission frame format in accordance with an embodiment of the present invention; and

FIGS. 8 through 10 are views, each illustrating information included in a transmission frame in accordance with an embodiment of the present invention.

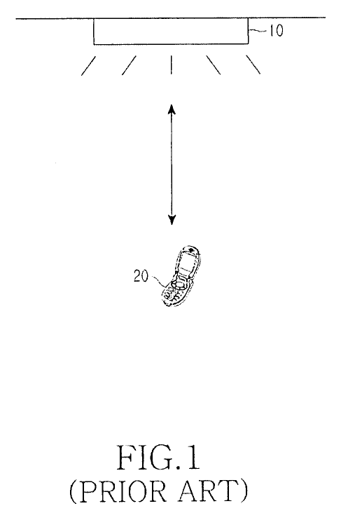

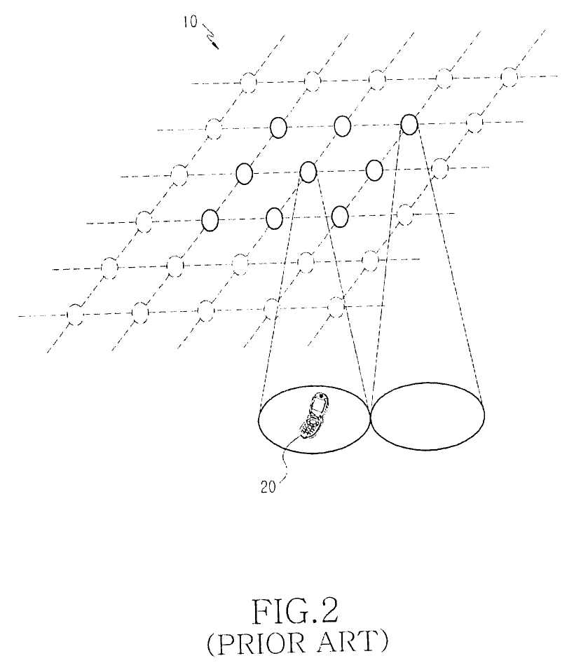

### DETAILED DESCRIPTION OF EMBODIMENTS OF THE INVENTION

Hereinafter, certain embodiments of the present invention will be described with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention. Further, it should be noted that only parts essential for understanding the operations according to the present invention will be described and a description of parts other than the essential parts will be omitted in order not to obscure the gist of the present invention.

A visible light communication system to which the present invention is applied transmits data by using a time division multiplexing scheme. More specifically, the visible light communication system multiplexes one light source or one cell into multiple channels by dividing multiple data and transmitting divided data in regular time slots respectively. The visible light communication system effectively and diversely transmits data over multiple channels by allocating time slots according to users, user services, or contents of visible light communication. The visible light communication system configures cells, each cell including at least one light source, and provides separate user services in units of cells. All light sources included in one cell provide the same type of user service, and one cell may provide one or more user services. The term “user service” refers to transmission of any data to a visible light communication terminal, and user services may be classified according to the types of contents to be transmitted, classified according to data transmission schemes, such as broadcasting and multicasting, or classified according to users. Also, all light sources included in one cell transmit the same data by using a specific downlink time slot. Thus, different light sources included in the same cell can transmit the same data.

In the visible light communication system to which the present invention is applied, time slot allocation may be dynamically changed according to service characteristics or communication environments in during performance of a particular user service. The number of light sources included in one cell may also be dynamically changed according to service characteristics or communication environments during performance of a particular user service. Further, light sources belonging to one cell may or may not neighbor each other, cells are not fixed, and each light source is configured according to logical mapping for light sources, rather than according to physical position.

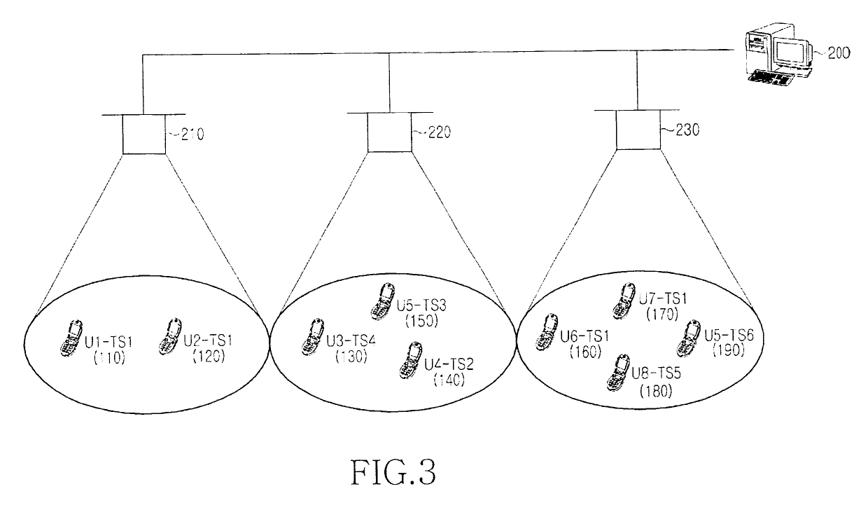

Visible light communication according to an embodiment of the present invention will be described in detail with reference to FIG. 3. FIG. 3 illustrates a structure of a visible light communication system according to an embodiment of the present invention. As illustrated in FIG. 3, the visible light communication system includes at least one visible light communication terminal 110, 120, 130, 140, 150, 160, 170, 180, and 190, at least one light source 210, 220, and 230, and a communication control apparatus 200.

Each visible light communication terminal 110, 120, 130, 140, 150, 160, 170, 180, 190 transmits/receives data in a visible light communication scheme by using a time slot, such as an uplink time slot or a downlink time slot, allocated thereto.

Each light source 210, 220, and 230 has a light source IDentifier (ID), which is a unique identifier allocated to each light source. Each light source 210, 220, and 230 also transmits transmission data, received from the communication control apparatus 200, to visible light communication terminals 110, 120, 130, 140, 150, 160, 170, 180, and 190 located in the coverage area of each respective light source. Also, each light source 210, 220, and 230 transmits reception data, received from each visible light communication terminal 110, 120, 130, 140, 150, 160, 170, 180, and 190, to the communication control apparatus 200. Thus, each light source 210, 220, and 230 includes at least one light emitting device and at least one light receiving device. Each light source 210, 220, and 230 acts as an access point in units of cells. For example, if one light source is mapped to one cell, then the one mapped light source acts as an access point. However, if a plurality of light sources is mapped to one cell, the plurality of light sources act as one access point.

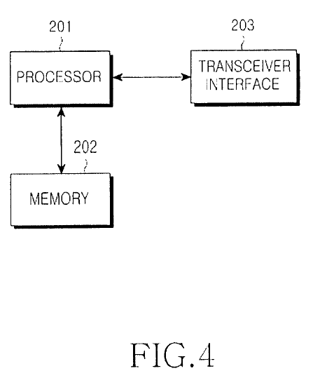

The communication control apparatus 200 manages light source IDs of all light sources connected thereto, configures cells including any light sources mapped to each cell according to user services to be provided in the light sources. The communication control apparatus 200 further allocates time slots, such as uplink time slots or downlink time slots, according to user services and data to be provided in each cell, and users located in each cell. This communication control apparatus 200 includes a processor 201, a memory 202, and a transceiver interface 204, as illustrated in FIG. 4.

The memory 202 stores various types (which may include all types) of program data for visible light communication, including light source IDs, user information, cell pattern information, time slot allocation information, etc. The memory 202 can also operate as a working memory of the processor 201. The transceiver interface 204 is an interface for performing data transmission/reception with multiple light sources. The processor 201 controls the overall operation of the communication control apparatus 200, processes data, and various types (which may include all types) of visible light communication operations of the communication control apparatus 200.

Since cells in a visible light communication system are determined according to user services to be provided by light sources, rather than determined according to geographic positions of light sources, sizes and shapes of the cells are not fixed. The number of light sources included in one cell is also not fixed, and there may be light sources that are not included in any cells. However, each cell must include at least one light source. A new cell may be formed, the size and shape of an already-formed cell may be changed, and cell a formation may be canceled according to user services or contents to be transmitted. Further, the above-listed operations are performed through a process of grouping light sources.

All of the light sources included in one cell may provide the same type of user service, and one or more user services may be provided in one cell. A user service may be classified according to the types of contents to be transmitted, data transmission schemes, such as broadcasting and multicasting, or classified according to users to be provided with services. Multiple time slots may be allocated to one cell, and all light sources included in one cell transmit data of the same content by using a specific downlink time slot.

Accordingly, the communication control apparatus 200 stores and manages user information, light source IDs, cell pattern information, etc. The term “user information” refers to information indicating characteristics of visible light communication users, and may include user IDs for user identification, a visible light communication terminal registered for each user, a terminal ID allocated to the corresponding visible light communication terminal, a user service set for each user, user preferences, etc. The cell pattern information refers to information indicating a current cell configuration and a time slot allocation status, and includes information regarding light sources included in each of currently configured cells, light sources not included in the cells, the types of user services and contents provided in each cell, each time slot allocated to users located in each cell, and currently unused time slots.

The communication control apparatus 200 groups light sources, maps the grouped light sources to cells, and allocates appropriate time slots to the cells with reference to the user information and cell pattern information. The communication control apparatus 200 does not allocate the same time slot to cells neighboring each other in terms of physical position. Therefore, time slots allocated to neighboring cells must be all different from each other. If the same time slot were used in neighboring cells, then different data could be transmitted through the same time slot in overlapping coverage areas of light sources belonging to the neighboring cells, which results in collision between the different data and interferes with effective visible light communication. However, according to an embodiment of the present invention, the same time slot for transmission of different contents may be allocated to non-neighboring cells, and thus different contents may be transmitted using the corresponding time slot in the respective cells. Also, one cell may be allocated multiple time slots according to the types of user services transmission contents provided in the cell, and users located in the coverage area of the cell. In the same manner, each of user services, users, or transmission contents may be allocated multiple time slots. The communication control apparatus 200 may allocate a new time slot to any cell when another user service is to be provided in addition to a user service that is currently being provided in the corresponding cell, or new data is to be provided in the corresponding cell.

For example, when an advertisement user service for broadcasting advertisement data is provided to many unspecified persons, the communication control apparatus 200 maps light sources, located in a target space for the advertisement user service, to one cell (cell A, for example), and allocates time slot A for use in broadcasting the advertisement data to cell A. Time slot A must be different from a time slot used in neighboring cell B. Each visible light communication terminal located in the coverage area of cell A is notified of time slot A, and the advertisement data is broadcast using time slot A. When a specific visible light communication terminal located in the coverage area of cell A generates a request for detailed advertisement information, the communication control apparatus 200 allocates another time slot (time slot B, for example) to cell A and the specific visible light communication terminal, and transmits detailed advertisement information data by using time slot B.

Through this process, the visible light communication system can improve system capacity in terms of coverage for cell users.

Another example according to an embodiment of the present invention will be described with reference to FIG. 3 as follows. In FIG. 3, each of a first light source 210, a second light source 220, and a third light source 230 may constitute an independent cell. A first cell including the first light source 210 broadcasts data by using a first time slot TS1, and thus, as shown in FIG. 3, both a first visible light communication terminal 110 and a second visible light communication terminal 120 receive data by using the first time slot TS1. A second cell including the second light source 220 provides a user service in which different data are transmitted to individual users by using multiple time slots. Thus, the individual data services are provided by allocating a second time slot TS2 to a fourth visible light communication terminal 140, allocating a third time slot TS3 to a fifth visible light communication terminal 130, and allocating a fourth time slot TS to a third visible light communication terminal 130. A third cell including the third light source 230 provides a user service in which a multicast service is mixed with individual data services. Thus, a multicast service is provided to a sixth visible light communication terminal 160 and a seventh visible light communication terminal 170 by using the first time slot TS1, and different data are transmitted to an eighth visible light communication terminal 180 and a ninth visible light communication terminal 190 by allocating a fifth time slot TS5 to the eighth visible light communication terminal 180 and allocating a sixth time slot TS6 to the ninth visible light communication terminal 190. Although the first time slot TS1 is also used in the first cell, visible light communication can be properly provided in both the first and third cells because the first and third cells do not neighbor each other.

If the communication control apparatus 200 is to provide a service in a wider area than the coverage area of any currently configured cell, or to reduce an area where a service is provided, then the communication control apparatus 200 may additionally map light sources, which exist around a current cell, to the current cell, or exclude some of light sources included in the current cell. Light sources included in a cell may be dynamically changed, and thus the cell may have a dynamic structure.

Once allocation of time slots is completed, the allocated time slots are announced to visible light communication terminals to which user services are provided, or data that is allocated the time slots is announced to the visible light communication terminals. Thus, a transmission frame includes an ID (Access Point ID) of a light source that transmits data by using a corresponding time slot, the total number of time slots, an ID of the corresponding time slot, and an ID of a relevant visible light communication terminal.

When the communication control apparatus 200 provides a cell with a broadcast service according to the present invention, the communication control apparatus 200 transmits broadcast information to visible light communication terminals located in the coverage area of the corresponding cell. The broadcast information includes broadcast mode announcement information indicating that the broadcast service is to be provided, information indicating the total amount of transmission of data provided by the broadcast service, and information indicating time points corresponding to the beginning and termination of the broadcast service. For example, the broadcast information may include information on a frame with which the broadcast service starts, information on frame period during which the broadcast service continues, information on a slot period during which the broadcast service continues, or other such information. If the amount of data to be broadcast is large, then a period during which the broadcast service continues is preferably determined in units of frames.

The broadcast information is configured in the manner described above since, if a visible light communication terminal transmits data in uplink while the broadcast service is performed, interference is caused, and thus the broadcast service cannot be properly performed. For example, when there is a large amount of data to be broadcast, even a frame period previously designated for use in an uplink may be used in a downlink, in the case of a unicast or multicast service. Alternatively, all data periods of a frame may be used in downlink. However, since multicast, unicast, and broadcast services may coexist in one cell, interference may be caused in downlink for the broadcast service when any terminal transmits uplink data during the broadcast service.

The broadcast mode announcement information and the broadcast information to be transmitted to a visible light communication terminal may be included in a control information field of a transmission frame or may be included in an uplink or downlink map according to formats of transmission frames.

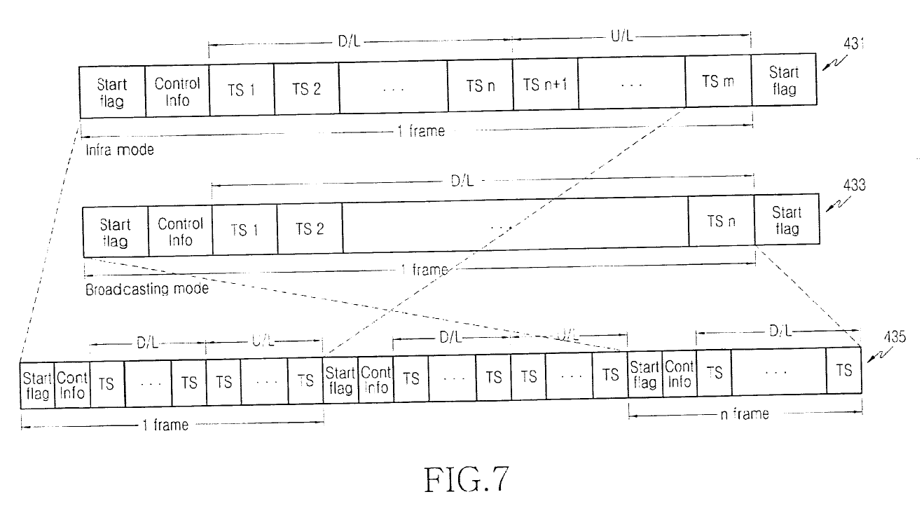

FIG. 7 illustrates a transmission format according to an embodiment of the present invention.

Referring to FIG. 7, a hybrid frame mode format 435 may be configured to include both an infra mode format 431 and a broadcast mode format 433.

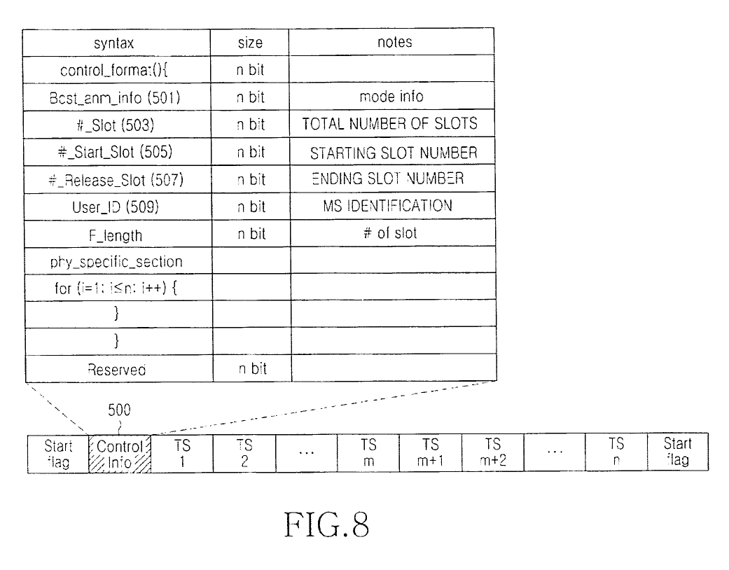

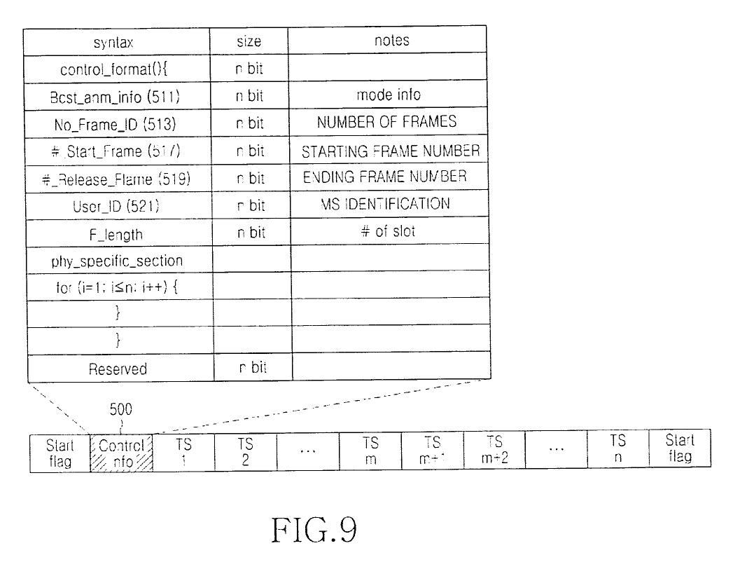

The broadcast mode announcement information and the broadcast information may be transmitted while being included in a control information field according to transmission frame formats illustrated in FIGS. 8 and 9. FIG. 8 shows information that is included in a control information field 500 when the broadcast service transmits data in units of slots, and FIG. 9 shows information that is included in the control information field 500 when the broadcast service transmits data in units of frames.

Referring to FIG. 8, in a slot-by-slot broadcast service, the control information field 500 includes broadcast mode announcement information (Bcast_anm_info) 501, the total number of slots (#_slot) 503, which may indicate the total amount of data transmitted through the broadcast service, a start slot number (#_Start_Slot) 505 and a release slot number (#_Release_Slot) 507, which may indicate broadcast service starting and ending time points, and a user ID (User_ID) 509 indicating a target terminal for the broadcast service.

Referring to FIG. 9, in a frame-by-frame broadcast service, the control information field 500 includes broadcast mode announcement information (Bcast_anm_info) 511, frame numbers (No_Frame ID) 513 indicating frames to be used in the broadcast service, a start frame number (#_Start_Frame) 517 and a release Frame number (#_Release_Frame) 519, which may indicate broadcast service starting and ending time points, and a user ID (User_ID) 521 indicating a target terminal for the broadcast service.

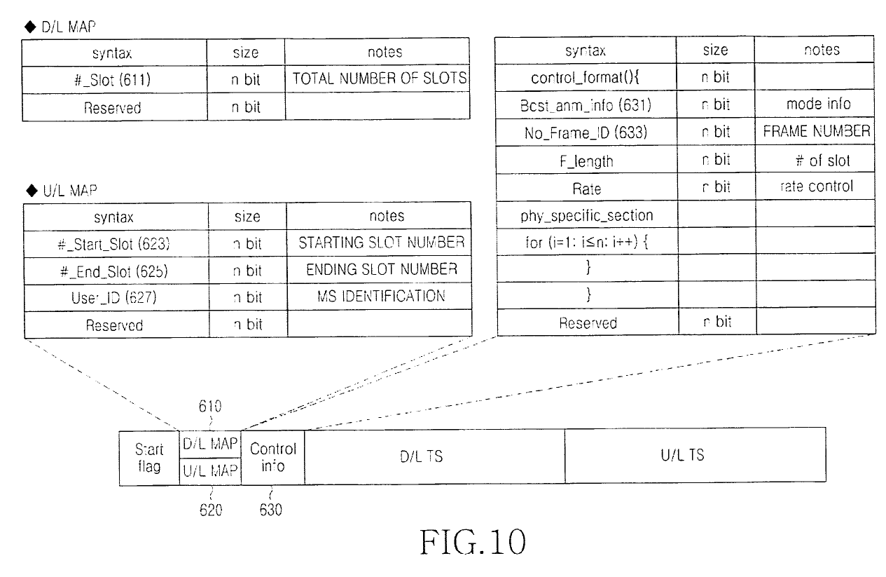

For a frame format using downlink and uplink maps, the broadcast mode announcement information and the broadcast information are included in a frame, as illustrated in FIG. 10.

Referring to FIG. 10, a control information field 630 includes Bcast_anm_info 631, which includes broadcast mode announcement information, and No_Frame ID 533 indicating frames for use in the broadcast service. The DownLink map (D/L MAP) 610 includes #_slot 611, which may indicate the total amount of data transmitted through the broadcast service. Finally, the UpLink map (U/L MAP) 620 includes #_Start_Slot 623 and #_Release_Slot 625, which may indicate broadcast service starting and ending time points, and User_ID 627 indicating a target terminal for the broadcast service.

The frame formats in FIGS. 8 to 10 are merely examples according to embodiments of the present invention. However, the storage location of each information item may be changed in accordance with the present invention.

On receiving the broadcast mode announcement information and the broadcast information through the control information field or downlink/uplink map, the visible light communication terminal informs its user of the broadcast mode, and prohibits uplink data transmission as long as the broadcast mode continues.

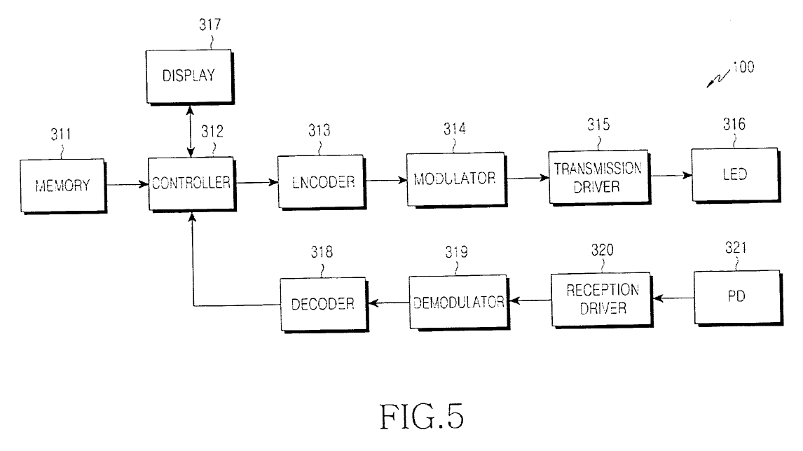

A visible light communication terminal according to an embodiment of the present invention is illustrated in FIG. 5. Referring to FIG. 5, the visible light communication terminal 100 includes a memory 311, a controller 312, an encoder 313, a modulator 314, a transmission driver 315, an LED 316, a display 317, a decoder 318, a demodulator 319, a reception driver 320, and a PhotoDiode (PD) 321.

The encoder 313 encodes transmission data input from the controller 312, and outputs the encoded data to the modulator 314. The modulator 314 modulates input transmission data, and outputs the modulated transmission data to the transmission driver 315. The transmission driver 315, which is a driver for the LED 316, optionally modulates transmission data input from the modulator 314 according to the wavelength band of the LED 316, and drives the LED 316. The LED 316 is a light emitting device for transferring transmission data to an external device by using an optical signal. A visible light communication terminal according to the present invention may include a light emitting device of types other than an LED.

The PD 321 is a light receiving device for detecting an optical signal transferred from an external device. The PD 321 receives an optical signal including received data from a light source, converts the received optical signal into an electrical signal, and outputs the converted electrical signal to the reception driver 320. The visible light communication terminal according to the present invention may include a light receiving device of types other than a PD. The reception driver 320, which is a driver for the PD 321, drives the PD 321, and outputs an electrical signal, input from the PD 321, to the demodulator 319. The demodulator 319 demodulates an electrical signal input from the reception driver 320, into data complying with an optical wireless scheme, thereby outputting the received data to the decoder 318. The decoder 318 decodes input received data, and outputs the decoded data to the controller 312. The controller 312 appropriately processes received data input from the decoder 318.

The display 317 displays various types of data under a control of the controller 312.

The memory 311 stores programs for processing and control of the controller 312, reference data, various updatable repository data, etc., and may also serve as a working memory for the controller 312. Also, the memory 311 stores broadcast mode announcement information and broadcast information received through a visible light communication frame.

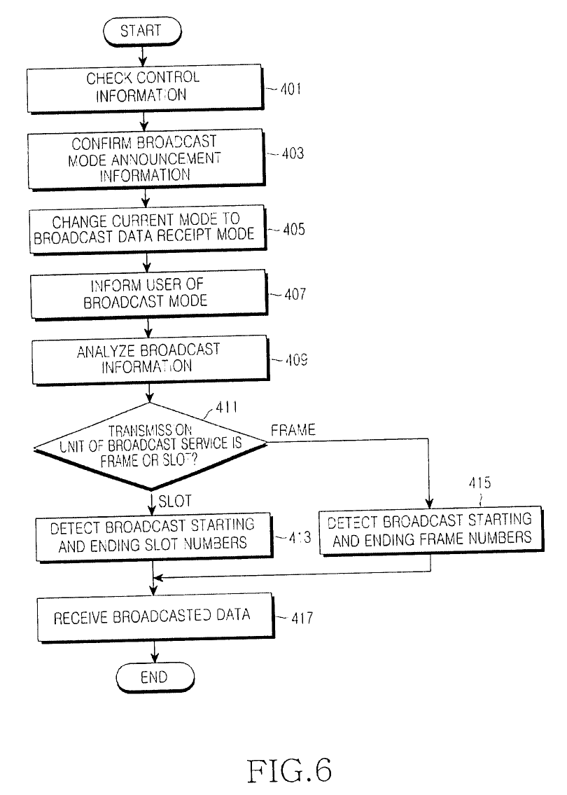

The controller 312 processes data for the purpose of data transmission/reception according to visible light communication, controls the respective constituent parts, and controls the overall operation of the visible light communication terminal 100. When broadcast mode announcement information and broadcast information are received, the controller 312 performs a procedure illustrated in FIG. 6.

Referring to FIG. 6, in step 401, the controller 312 of the visible light communication terminal 100 checks control information or a downlink/uplink map, and proceeds to step 403. In step 403, the controller 312 confirms whether broadcast mode announcement information is included in the control information or downlink/uplink map. In step 405, the controller 312 changes a current mode to the broadcast data receipt mode, and proceeds to step 407. In step 407, the controller 312 issues a broadcast mode alert sound, displays a broadcast mode indicator on the display 317 (or performs another notification indicating the broadcast mode), thereby informing the user of the visible, light communication terminal 100 that the broadcast data receipt mode has been set. In step 409, the controller 312 analyzes broadcast information, and particularly checks the data transmission unit of the broadcast service in step 411. According to the result of the analysis performed in steps 409 and 411, the controller 312 proceeds to step 413 when data is transmitted in units of slots, or alternatively proceeds to step 415 when data is transmitted in units of frames. In steps 413 and 415, the controller 312 discovers broadcast starting and ending slot numbers or broadcast starting and ending frame numbers, and proceeds to step 417. In step 417, the visible light communication terminal 100 receives broadcast data.

The controller 312 controls the visible light communication terminal 100 such that the visible light communication terminal 100 does not transmit data in uplink while the broadcast data receipt mode is set. Therefore, if a request for uplink data transmission is made, then the controller 312 checks a currently set service mode, and does not transmit data when the currently set service mode is the broadcast data receipt mode. Also, if a request for uplink data transmission is received from the user while the broadcast mode continues, the controller 312 may confirm that the broadcast data receipt mode is currently maintained, and prevent data transmission by displaying an indicator indicating the broadcast mode or issuing an alert sound.

The procedure illustrated in FIG. 6 is performed when the visible light communication terminal 100 is designated as a target terminal for the broadcast service. However, even when the visible light communication terminal 100 is not designated as a target terminal for the broadcast service, on receiving the broadcast service announcement information and the broadcast information, the visible light communication terminal 100 can inform a user that the broadcast service is currently being provided, thereby prohibiting uplink data transmission while the broadcast service continues.

As described above, in accordance with the embodiments of the present invention, a visible light communication control apparatus transmits information on the amount of data provided through a broadcast service, together with broadcast mode announcement information indicating the broadcast service, so that the uplink of a visible light communication terminal can be prevented from being used during the broadcast service, and thus the broadcast service can be properly provided.

While the present invention has been shown and described with reference to certain embodiments thereof, it will be understood by those skilled in the art that various changes in form and details may be made therein without departing from the spirit and scope of the invention. For example, although above-described embodiments include a case where broadcast mode announcement information is transmitted when a broadcast service is provided, it may also be possible to transmit transmission mode announcement information for other services, such as, multicast and unicast services. In this case, transmission period information indicating a period during which a corresponding transmission mode is maintained may be transmitted together with the transmission mode announcement information. Therefore, the scope of the invention is not limited to the embodiments as described above, but is defined by the appended claims and equivalents thereof.

What is claimed is:

1. A method for providing a visible light communication terminal with a visible light communication service in a time division visible light communication system providing the service in various transmission schemes, the method comprising the steps of:
receiving transmission mode announcement information corresponding to one of the various transmission schemes from a communication control apparatus providing the visible light communication service;
checking the transmission mode announcement information;
storing a result of the checking in the visible light communication terminal; and
when the result of the checking indicates that a broadcast mode is set, controlling a transmission of uplink data by the visible light communication terminal.

2. The method as claimed in claim 1, further comprising, when the visible light communication terminal has data to be transmitted to the communication control apparatus, checking mode information from the communication control apparatus, which is stored in the terminal.

3. The method as claimed in claim 1, wherein transmission period information includes information regarding starting and ending points of the transmission scheme corresponding to the transmission mode announcement information, and
wherein the transmission period information is received together with the transmission ode announcement information.

4. The method as claimed in claim 1, further comprising, when a request for data transmission to the communication control apparatus is received, displaying an indicator indicating the transmission scheme corresponding to the transmission mode announcement information.

5. The method as claimed in claim 4, wherein the transmission mode announcement information corresponds to a broadcast mode, and the transmission period information includes information regarding starting and ending points of the broadcast mode.

6. The method as claimed in claim 5, wherein the transmission period information includes information regarding a frame with which the broadcast mode starts, and
wherein a broadcast service corresponding to the broadcast mode is provided in units of frames.

7. The method as claimed in claim 6, wherein the transmission mode announcement information and the transmission period information are transmitted within any one of control information, an uplink map, and a downlink map of a transmission frame.

8. A visible light communication terminal that is provided with a broadcast service in a time division visible light communication system that provides the broadcast service, a multicast service, and a unicast service, the visible light communication terminal comprising:
a light emitting device;
a light receiving device; and
a controller for outputting a user notification indicating a broadcast mode when the light receiving device receives broadcast mode announcement information from a communication control apparatus providing a visible light communication service, and controlling for preventing an uplink data transmission during the broadcast mode.

9. The visible light communication terminal as claimed in claim 8, wherein broadcast period information including information regarding starting and ending points of the broadcast service is received together with the broadcast mode announcement information.

10. The visible light communication terminal as claimed in claim 9, wherein the controller receives broadcast data according to broadcast information transmitted from the communication control apparatus.

11. The visible fiat communication terminal as claimed in claim 10, wherein the broadcast period information includes information regarding a frame with which the broadcast service starts, and
wherein the broadcast service is provided in units of frames.

12. The visible light communication terminal as claimed in claim 11, wherein the broadcast mode announcement information and the broadcast information are transmitted within any one of control information, an uplink map, and a downlink map of a transmission frame.

13. A method for providing a broadcast service by a communication control apparatus in a time division visible light communication system that provides the broadcast service, a multicast service, and a unicast service, the method comprising the steps of:
transmitting broadcast mode announcement information and broadcast period information to a visible light communication terminal in order to prohibit uplink data transmission during the broadcast service; and
transmitting broadcast data during a broadcast period.

14. The method as claimed in claim 13, wherein the broadcast period information includes information regarding starting and ending points of the broadcast service.

15. The method as claimed in claim 14, wherein the broadcast period information includes information regarding a frame with which the broadcast service starts, and
wherein the broadcast service is provided in units of frames.

16. The method as claimed in claim 15, wherein the broadcast mode announcement information and the broadcast period information are transmitted within any one of control information, an uplink map, and a downlink map of a transmission frame.

17. A communication control apparatus for providing a broadcast service in a time division visible light communication system that provides the broadcast service, a multicast service, and a unicast service, the communication control apparatus comprising:
a transceiver interface for transmitting data to at least one light source connected to the communication control apparatus and receiving data from at least one light source connected to the communication control apparatus; and
a processor for transmitting broadcast mode announcement information and broadcast period information to a visible light communication terminal through the transceiver interface in order to prohibit uplink data transmission during the broadcast service, and transmitting broadcast data during a broadcast period.

18. The communication control apparatus as claimed in claim 17, wherein the broadcast period information includes information regarding starting and ending points of the broadcast service.

19. The communication control apparatus as claimed in claim 18, wherein the broadcast period information includes information regarding a frame with which the broadcast service starts, and
wherein the broadcast service is provided in units of frames.

20. The communication control apparatus as claimed in claim 19, wherein the broadcast mode announcement information and the broadcast period information are transmitted within any one of control information, an uplink map, and a downlink map of a transmission frame.
